(19) United States
(12) Patent Application Publication
(10) Pub. No.: US 2003/0204695 A1
(43) Pub. Date: Oct. 30, 2003

(54) Dual processor apparatus capable of burst concurrent writing of data

(76) Inventors: Joo-Yong Park, Songnam-shi (KR); Byung-Gu Choe, Seoul (KR)

Correspondence Address: Robert E. Bushnell, Suite 300, 1522 K Street, N.W., Washington, DC, 20005, US

(21) Appl. No.: 10/358,225

(22) Filed: Feb. 5, 2003

(30) Foreign Application Priority Data
Apr. 29, 2002 (KR) 2002-23404

(51) Int. Cl. G06F 12/00

(52) U.S. Cl. 711/167; 711/168

(57) ABSTRACT

A dual processor apparatus is capable of burst concurrent writing of data during a burst cycle in a communication system including two processors, one of which is in active mode, when the other is in standby mode. The processor in standby mode is operated in dependence on the control of the processor in active mode. In the apparatus, the central processing unit of the processor in active mode generates a dual request signal and provides a burst cycle, which can continuously record n data blocks with one row address strobe signal and n column address strobe signals, thereby storing n data blocks in a dynamic memory inside of the processor during the burst cycle and transmitting the stored data and corresponding addresses to the processor in standby mode each time when the storing is executed; and the central processing unit of the processor in standby mode recognizes the start of burst cycle concurrent writing if a dual request signal and a burst signal are received from the processor in active mode, and stores the data received from the processor in active mode in a corresponding position in accordance with the addresses received from the processor in active mode. The apparatus enhances reliability and improves performance in connection with the demand for data communication control by a routing processor controller used in super-high speed communication networks or for dualization for a main controller used in various communication networks.

### CLAIM OF PRIORITY

This application makes reference to, incorporates the same herein, and claims all benefits accruing under 35 U.S.C. §119 from an application for DUAL PROCESSOR APPARATUS CAPABLE OF BURST CONCURRENT WRITING OF DATA earlier filed in the Korean Industrial Property Office on Apr. 29, 2002 and there duly assigned Serial No. 2002-23404.

### BACKGROUND OF THE INVENTION

1. Field of the Invention

The present invention relates to a dual processor apparatus for a high speed communication system, and more particularly to an apparatus for controlling dynamic memories of two processors in such a manner that the dynamic memories can perform concurrent writing of data in a burst cycle.

2. Description of the Related Art

In general, processor dualization is realized to enhance reliability. In other words, two identical processors are used, in which one of them is in active state and the other is in standby state, whereby if trouble occurs in the former, the latter is turned to active state, thereby ensuring reliability.

In order to realize such dualization, the data of two processors' memories should be in conformity with each other, although operations of reading data from or writing data into each of the memories of processors are allowed to be generated sequentially or concurrently, as needed. For this, good synchronization is necessary. An example of sequential synchronization is to reproduce the data of the active side memory into the standby side memory for a predetermined length of time. For this purpose, an application program is needed for allowing the control section of the active side to reproduce the data of the active side into the standby side. An example of concurrent synchronization is to allow the data of the active side memory and standby side memory to be concurrently processed in real time through the hardware. Hereinafter, synchronous or synchronization is used to mean the latter case.

Up to now, because single writing has been executed to concurrently record data into active side and standby side dynamic memories, not only a lot of time for data synchronization (data conformity of active side and standby side dynamic memories) was needed but also the overhead time was correspondingly increased depending on memory capacity.

In addition, although various high performance processors have been used for implementing a high speed communication network, data synchronization performance through dualization was relatively low as compared to the performance of such processors, and thus there was a problem in reliability of data.

One of the many problems of the earlier art is that considerable time is required if the data is of a large amount. Furthermore, when a writing cycle is dualized, a performance falling-off of about 30% is caused in terms of physical time as compared to the case in which it is not dualized, whereby a serious problem may be produced in the aspect of performance if a function using such a writing cycle is employed in a super-speed communication network or equipment which requires high performance.

### SUMMARY OF THE INVENTION

It is therefore an object of the present invention to provide an apparatus for controlling a communication system with a processor dualized so that data can be concurrently recorded into a dynamic memory of each processor during burst cycle.

It is another object to enhance reliability and improve performance in connection with the demand of data communication control of a routing processor controller used in very high speed communication networks or dualization for a main controller used in various communication networks.

It is still another object of the present invention to provide an apparatus for controlling a communication system with a processor dualized so that data can be concurrently recorded into a dynamic memory of each processor during burst cycle and yet bet easy and inexpensive to implement and manufacture.

In order to accomplish the above and other objects, there is provided a communication system including two processors, one of which is in active mode when the other is in standby mode, the processor in standby mode being operated in dependence on the control of the processor in active mode.

The central processing unit of the processor in active mode generates a dual request signal and provides a burst cycle, which allows n data blocks to be continuously recorded with one row address strobe signal and n column address strobe signals, thereby storing n data blocks in a dynamic memory inside of the processor during the burst cycle and transmitting the stored data and a corresponding address to the processor in standby mode each time when the storing is executed.

The central processing unit of the processor in standby mode recognizes the start of a burst cycle of concurrent writing if the dual request signal and a burst signal received from the processor in active mode, and stores the data received from the processor in active mode in a corresponding position in accordance with the addresses received from the processor in active mode, whereby the two processors are capable of concurrent writing of data during the burst cycle.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a construction of a conventional dual processor apparatus of communication system;

FIG. 2 is a timing diagram illustrating a process of implementing-concurrent writing in memory modules of conventional dual dynamic memory based on a single cycle;

FIG. 3 shows a construction of a dual processor apparatus for an communication system in accordance with an embodiment of the present invention;

FIG. 4 is a timing diagram illustrating a process of implementing concurrent writing in memory modules of a dual dynamic memory in accordance with an embodiment of the present invention based on a burst cycle; and

FIG. 5 is a state transition diagram of a dynamic memory in accordance with an embodiment of the present invention.

### DETAILED DESCRIPTION OF THE PREFERRED EMBODIMENTS

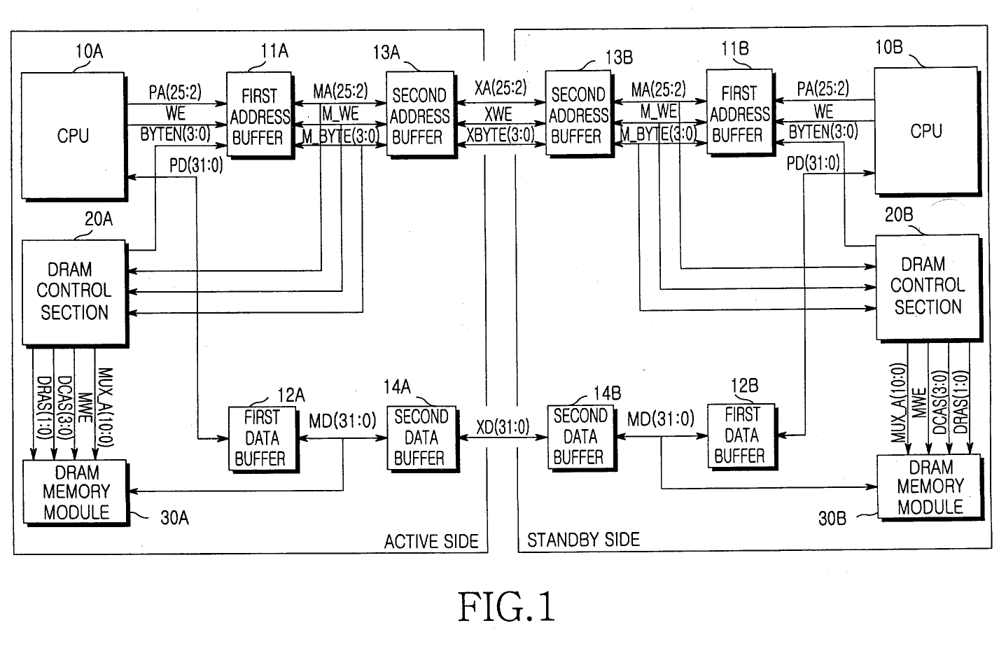

Turning now to the drawings, FIG. 1 illustrates a construction of a conventional dual processor apparatus.

The illustrated dual construction is divided into an active side and a standby side, and the constituent components of the active side and standby side are the same with each other. However, in the drawing, each of reference numerals of components is appended with “A” or “B” to easily grasp in which side a component is included, in the active side or the standby side. For convenience, it is assumed that the first processor, on the left side, is on active mode and the second processor, on the right side, is on standby mode. Both processors individually include a large capacity Dynamic Random Access Memory (DRAM), and the processor on active mode can concurrently access two DRAMs either sequentially or randomly.

Reference symbols, PA, WE, BYTEN, and PD are abbreviations of “processor address,” “write enable,” “byte enable,” and “processor data,” respectively. Signals indicated by these reference symbols pass through buffering and transferring processes in the active side and standby side, and thus different reference symbols are used merely for classification by process. BYTEN is a signal for enabling a signal corresponding to each byte size of DRAM memory module and selecting an access cycle for the purpose of reading or writing of data.

CPUs 10A, 10B respectively control the whole operation of a corresponding processor in accordance with active or standby mode. The operation includes generating an address, or reading various data from a memory or writing various data into the data. DRAM controllers 20A, 20B produce signals DRAS (1:0), DCAS (3:0), and MWE for controlling DRAM memory modules 30A, 30B, and row/column multiplex addresses MUX_A (10:0). The DRAS is the abbreviation of “DRAM Row Address Strobe,” the MWE is the abbreviation of “Memory Write Enable,” and the MUX_A is the abbreviation of “Multiplexing Address.” The first address buffers 11A, 11B and the first data buffers 12A, 12B transfer generated addresses and data. The second address buffers 13A, 13B and the second data buffers 14A, 14B are connected to the first address buffers 11A, 11B and the first data buffers 12A, 12B, respectively, and safely and correctly transfer dual control signals/addresses (signals and addresses) and dual DRAM data to the counter side (active side or standby side). DRAM memory modules 30A, 30B are memory mediums controlled by DRAM control sections 20A, 20B to store data.

The process, in which the processor on active mode concurrently records data into its own DRAM memory module 30A and into the DRAM memory module 30B of the processor on standby mode, so that the processor in active mode and processor in standby mode can maintain identical data, is explained as follows.

The CPU 10A of the processor in active mode generates data to be stored and a corresponding address. The first address buffer unit 11A buffers and transfers the address to the DRAM control section 20A and second address buffer 13A. In addition, the first data buffer 12A buffers and transfers the data to the DRAM memory module 30A and second data buffer. As a result, the DRAM memory module 30A will store the transferred data into the transferred address. Also, in order for the same data to be also stored into the DRAM memory module 30B of the processor in standby mode, the second data buffer 14A buffers the data transferred from the first data buffer 12A and transfers it to the processor in standby mode. In addition, the second address buffer 13A buffers the data transferred from the first address buffer 11A and transfers it to the processor in standby mode.

At this time, the second address buffer 13B of the processor in standby mode buffers the address transferred from the second address buffer 13A of the processor in active mode and transfers it to the DRAM control section 20B and the first address buffer 11B. The second data buffer 14B buffers the data transferred from the second data buffer of the processor in active mode and transfers it to the DRAM memory module 30B and the first data buffer 12B. As a result, the DRAM memory module 30B will be stored with the data transferred from the the processor in active mode in the position of the transferred address.

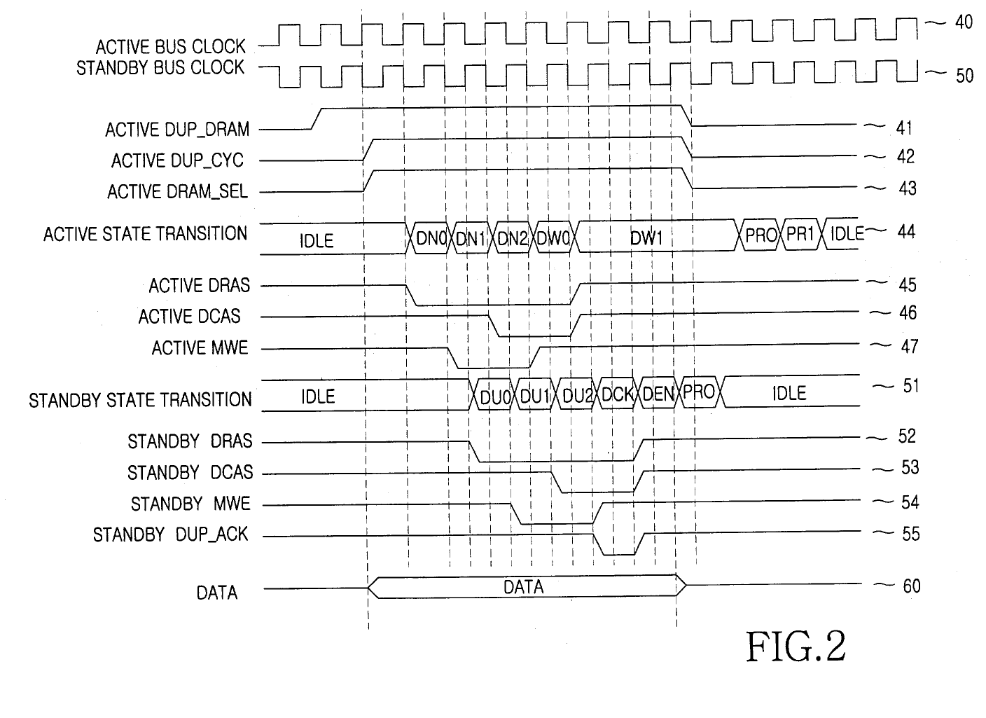

FIG. 2 is a timing diagram indicating the process of implementing concurrent writing to conventional dual DRAM memory module based on a single cycle.

Herein, the term single cycle means that the writing of one data block (4 bytes at maximum) is completed by one RAS (Row Address Strobe) signal and one CAS (Column Address Strobe) signal when data is concurrently stored in the active side DRAM memory module 30A and standby side DRAM memory module 30B.

Herein below, a process of implementing concurrent writing to the active side DRAM memory module 30A and the standby side DRAM memory module 30B will be described with reference to the relationship of active side timing 40˜47 and standby side timing 50˜55.

The CPU 10A generates data to be recorded in accordance with the active bus clock. The CPU 10A also generates a dual memory signal DUP_DRAM 41, and due to this generated signal, a dual cycle signal DUP_CYC 42 and a memory selecting signal DRAM_SEL 43 are generated in synchronization with the active bus clock 40. With the synchronized signals, an active side DRAM state transition 44 is started to generate DRAS 45, DCAS 46 and MWE 47. As a result, the data is stored in the DRAM memory module 30A while the MWE 47 maintains a low state. The dual cycle signal DUP_CYC 42 is a signal generated inside of the DRAM control section 20A, and by this signal, DRAS 45 and DCAS 46 are made.

Meanwhile, the standby side is synchronized with a standby bus clock 50 and starts the state transition of standby side DRAM state transition 51, if it receives the active side dual cycle signal DUP_CYC 42. In accordance with this state transition 51, DRAS 52, DCAS 53, and MWE 54 are generated. Thereby, the standby side DRAM memory module 30B is stored with data provided from the active side while the MWE 54 maintains a low state.

Data 60 shown in the drawing indicates data concurrently written by the active side and standby side through the above process.

After the data is stored in the standby side DRAM memory module 30B, the DRAM control section 20B generates dual response signal DUP_ACK 55. The active side CPU 10A terminates the concurrent writing cycle if it receives the dual response signal DUP_ACK 55. Thereby, the dual concurrent writing cycle is completely terminated.

In FIG. 1, however, because the DRAM control section 20A only provides a writing cycle if the CPU 10A generates data and starts concurrent writing, at most 4 bytes are transferred through the first address/data buffers 11A or 11B, 12A or 12B and the second address/data buffers 13A or 13B, 14A or 14B, there is a problem in that considerable time is required if the data is of a large amount. Furthermore, when a writing cycle is dualized, a performance falling-off of about 30% is caused in terms of physical time as compared to the case in which it is not dualized, whereby a serious problem may be produced in the aspect of performance if a function using such a writing cycle is employed in a super-speed communication network or equipment which requires high performance.

Hereinafter, preferred embodiments of the present invention will be described with reference to the accompanying drawings.

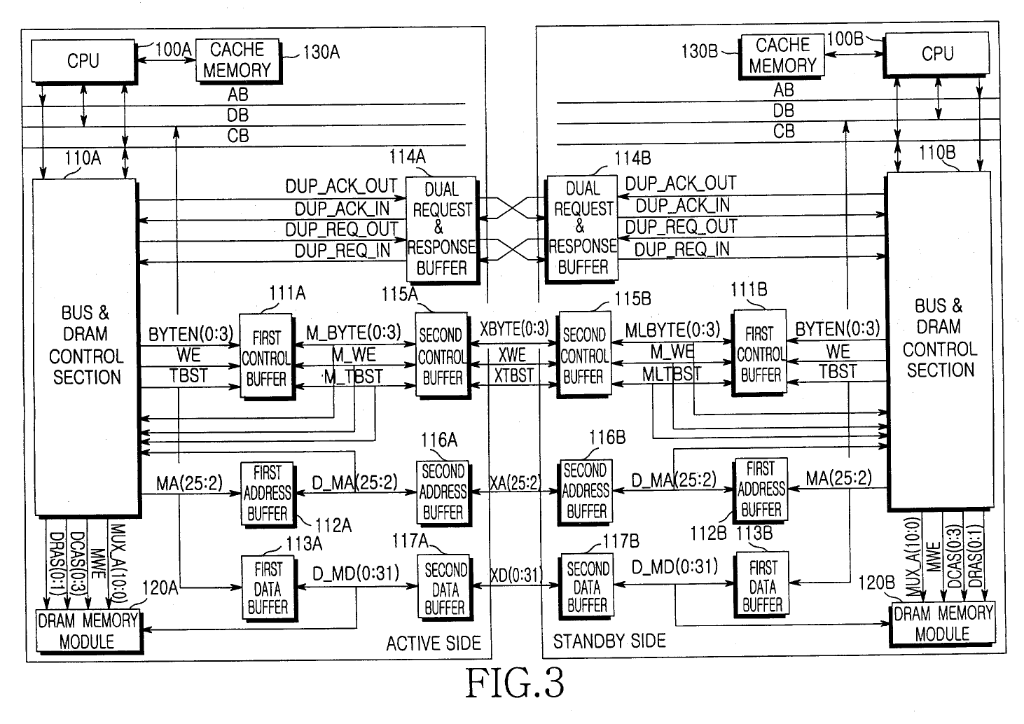

FIG. 3 shows a construction of a dual processor apparatus of a communication system in accordance with an embodiment of the present invention.

The dual construction will be described in connection with the first processor, which above has been assumed to be the active side, as an example.

A CPU 100A controls the whole operation of the processor according to active mode. The operation including generating an address, reading various data from a memory and writing various data into a memory. Furthermore, the CPU 100A aids the burst writing operation according to the present invention. A cache memory 130A (or 130B for CPU 100B) improves the performance of the CPU 100A declined due to an external memory cycle and aids the burst cycle. A bus and DRAM control section 110A not only takes charge of the peripheral bus control function of the CPU 100A, but also generates DRAM memory module 120A control signals DRAS (0:1), DCAS (0:3), MWE, a multiplex address generation signal MUX_A (10:0), a dual request signal DUP_REQ_IN, DUP_REQ_OUT, a dual response signal DUP_ACK_IN, DUP_ACK_OUT, control signals BYTEN (0:3), WE, TBST (Transfer Burst), a dual address MA (25:2), and a dual data MD (0:31). A control buffer 111A buffers the control signals BYTEN (0:3), WE, TBST and outputs them as dual control signals M_BYTE (0:3), M_WE, M_TBST. An address buffer 112A buffers the address signal MA (25:2) and outputs it as a dual address signal D_MA (25:2). A data buffer 113A buffers the data MD (0:31) and outputs it as a dual data D_MD (0:31). A dual request/response (request and response) buffer 114A is a means for transferring the dual request signal DUP_REQ_IN/OUT (input and output) and response signal DUP_ACK_IN/OUT (input and output). A second buffer 115A, a second address buffer 116A, and a second data buffer 117A individually have a means for and the function of directly transferring dual control signal, dual address and dual data to a standby side bus.

Herein, “burst cycle” means the time allowed for continuously processing (read/write) four data blocks (maximum 16 bytes) with one RAS (Row Address Strobe) signal and four CAS (Column Address Strobe) signals when reading data from a DRAM memory module or storing data therein. “Concurrent writing cycle” means the time taken to concurrently write data in the active side and standby side DRAM memory modules 30A, 30B.

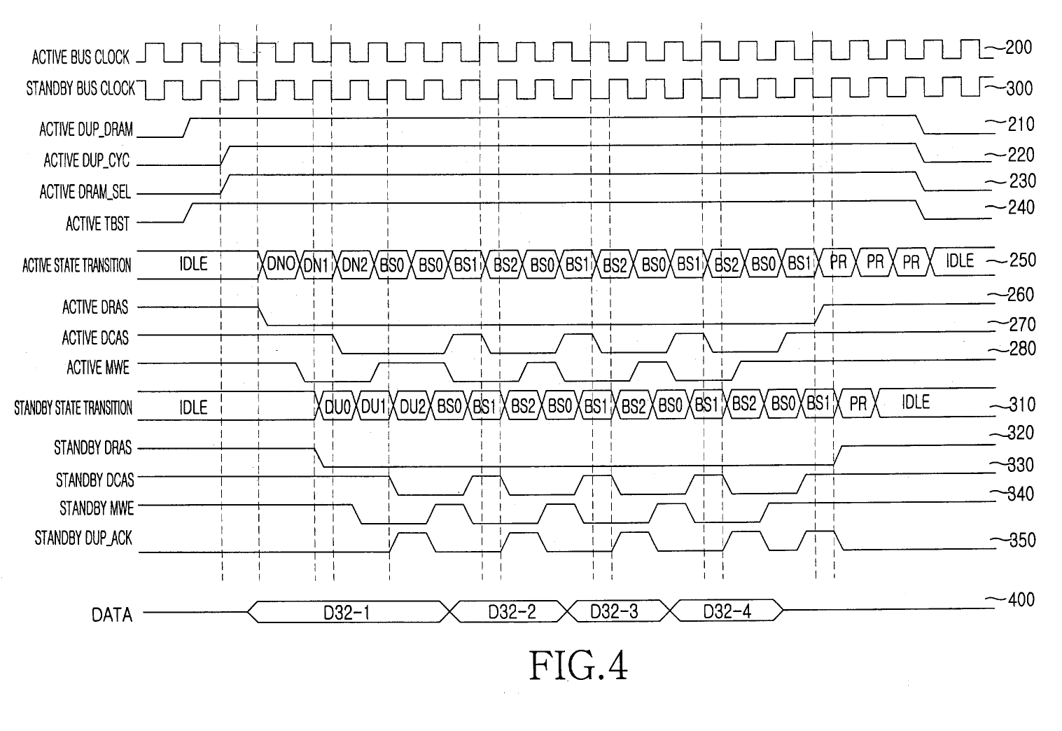

FIG. 4 is a timing diagram showing the process of implementing concurrent writing in dual DRAM memory modules in accordance with an embodiment of the present invention.

The state shown in the drawing is divided into active side timing 200˜280 and standby side timing 300˜350.

Firstly, the active side signals are defined as follows.

Dual DRAM signal, DUP_DRAM 210 is a signal generated by logic after the CPU 100A transfers an address and data to the bus control and DRAM control section 110A in order to start dualization.

Dual cycle signal, DUP_CYC 220 is a signal made by the active DUP_DRAM signal 210 to generate a dual cycle.

Memory selection signal, DRAM SEL 230 is a signal made to control the active side buffer during the dual cycle.

TBST (240) is a signal generated by the CPU 100A to make it possible to recognize the dual burst DRAM concurrent writing cycle within the bus and DRAM control section 100A, thereby executing state transition.

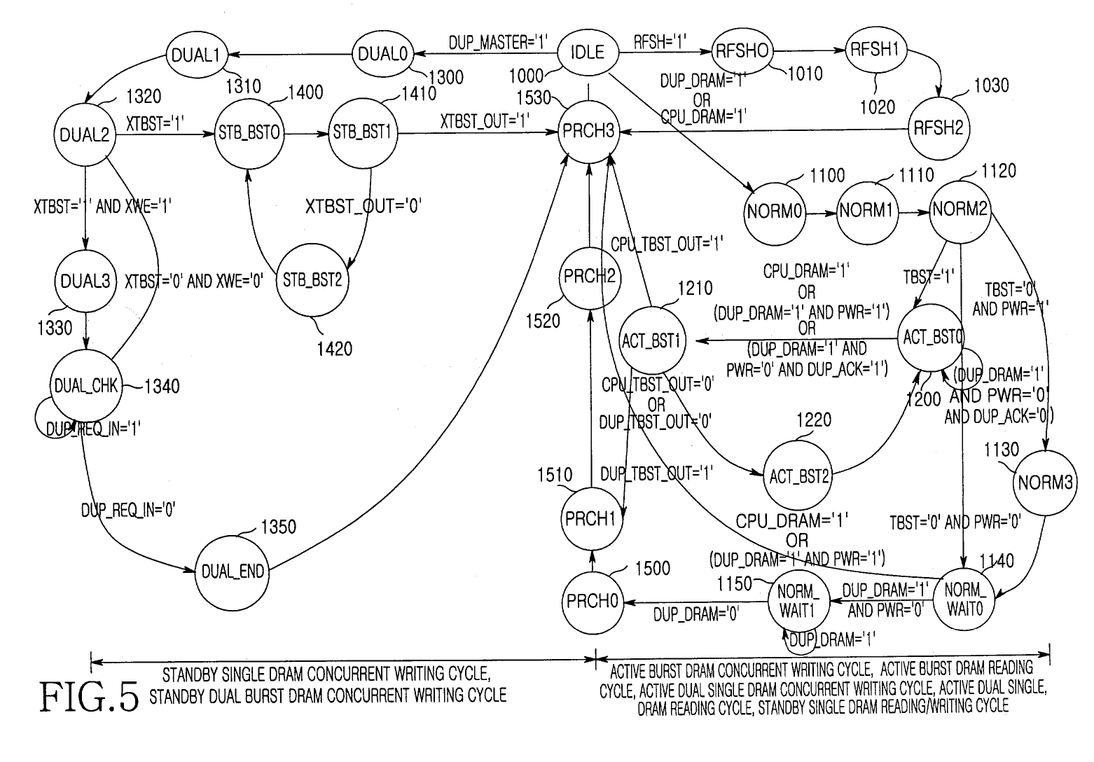

State transition 250 sequentially indicates the state transition generated within the bus and DRAM control section 100A. This may be indicated like that shown in the right of state transition diagram of FIG. 5 to be described below.

DRAS 260, DCAS 270, and MWE 280 are active side DRAM module selection and control signals for writing data in the active side DRAM memory module 120A in accordance with the state transition 250.

Next, the standby side signals are defined as follows.

State transition 310 sequentially indicates state transition generated within the bus and DRAM control section 110B. This maybe indicated like that shown on the left of the state transition diagram of FIG. 5 which is to be described below.

DRAS 320, DCAS 330, and MWE 340 are standby side DRAM module selection and control signals for writing standby side data in the standby side DRAM memory module 120A in accordance with the state transition 310.

DUP_ACK 350 is a signal related to dual request and response. Specifically, if a DUP_REQ_OUT signal is transmitted through the dual request and response buffer 114A from the active side to the standby side in order to concurrently execute writing of DRAM data, the signal (for convenience of differentiation, to be referred as “DUP_REQ_IN”) passed through the standby side dual request and response buffer 114B is transferred to the standby side bus and DRAM control section 10B. This signal generates a DUP_MASTER signal as shown in the left diagram of FIG. 5 to be described below, thereby causing recognition as to the dual cycle (DUAL0 (1300)). As a result of the recognition, a DUP_ACK_OUT signal, which is the response signal for the dual DRAM burst concurrent writing cycle, is transmitted to the active side through the dual request and response buffer 114B, and the signal (for convenience of differentiation, to be referred as “DUP_ACK_IN”) passed through the active side dual request and response buffer 114A is transferred to the active side bus and DRAM control section 110A.

The DUP_ACK 350 is generated only in the standby side bus and DRAM control section 110B in accordance with the state transition on the left side of the state transition diagram shown in FIG. 5 which is to be described below. First and second high states are generated by DUAL2 (1320) and STB_BST2 (1420) of FIG. 5, respectively, third and fourth high states are also generated by STB_BST2 (1420), and fifth high state is generated if XTBST_OUT is turned to ‘1’ in the state of STB_BST1 (1410).

The fifth high state is additionally described as follows.

In the left side diagram of FIG. 5 to be described below, the XTBST_OUT signal is the signal generated if the standby burst cycle is terminated. When the standby side state transition is started, that is, if standby side XTBST=‘1’, the start of standby side burst cycle is recognized and count of XTBST signal (standby burst cycle) is started, and if the burst cycle is terminated, the XTBST_OUT signal is generated. In the states of STB_BST1 (1410), the XTBST_OUT signal is checked, and if the XTBST_OUT=‘1’, the fifth high state is made in order to indicate that the standby side burst cycle has been terminated.

The process of implementing concurrent writing in DRAM memory modules on the basis of burst cycle using the signals as defined above will be described as follows.

If the CPU 100A generates data in accordance with the synchronization of the active side bus clock 200, the active side dual DRAM signal DUP_DRAM 210, dual cycle signal DUP_CYC 220, memory selection signal DRAM_SEL 230, and burst generation signal TBST 240 are generated synchronously with the bus clock 200. With the generation of the signal, the active side DRAM state transition 250 is started, and the DRAS signal 260, DCAS signal 270 and MWE signal 280 are generated and stored in the DRAM memory module 120A.

Comparing the toggled times of the aforementioned active side MWE signal 47 of FIG. 2 and MWE signal 280 of FIG. 4, they are one time and four times, respectively. This is because the burst writing (e.g., four times) is executed in the embodiment of the present invention while the single writing is executed in the conventional case.

Meanwhile, the standby side starts the standby side DRAM state transition 310 synchronously with the bus clock 300 if the active side dual cycle signal DUP_CYC 220 and TBST 240 are received. In accordance with this state transition 310, the standby side DRAS signal 320, DCAS signal 330 and MWE 340 are generated, whereby the standby side DRAM memory module 120B will be stored with the same data as with those of the active side.

Here, it is important that continuous offset addresses must be generated in accordance with the active side DCAS signal 270 because the burst (continuous) concurrent writing cycle should be enabled. For this purpose, the dual response signal DUP_ACK 350 for the burst cycle is repeatedly provided over five times from the standby side in accordance with effective time as shown in the drawing. The standby side dual response signal DUP_ACK 350 is used for generating continuous offset signals of the active side DCAS signal 270 up to four times and is used for terminating the concurrent writing of active side burst cycle at the fifth and last time.

DN in “DN0” of the active state transition 250 is the abbreviation of DRAM normal cycle. In addition, same burst cycle BS0 is repeated two times to tune the whole cycle. DU in “DU0” of the standby state transition 310 is the abbreviation of dual cycle. In both of the active and standby state transitions 250, 310, the reference symbol PR indicates the precharge time.

FIG. 5 is the state transition diagram of the DRAM control section in accordance with an embodiment of the present invention.

In the communication system dualized with first and second processors, the dynamic memory control section of each processor implements a part of state transition shown in the drawing according to the existing condition. In other words, the state transition as shown in the drawing can be generated in each of the processors, and it may be changed depending on the conditions such as active/standby (active and standby), single/burst (single and burst), sole writing/concurrent writing (sole writing and concurrent writing).

For example, if the first processor executes concurrent writing of its own DRAM and DRAM of the second processor which is standby, a right side state transition in the first processor will occur and a left side state transition in the second processor will occur, in reference to the waiting state 1000.

In reference to the waiting state 1000, the left side indicates the aspect of state transition which occurred in the dynamic memory in the case of standby single DRAM concurrent cycle or standby dual burst DRAM concurrent writing cycle. However, the right side indicates the aspect of state transition which occurred in the dynamic memory in the case of standby single DRAM reading/writing cycle, active burst DRAM concurrent writing cycle, active dual single DRAM concurrent writing cycle, or active dual single DRAM reading cycle.

The above states are related to aforementioned FIG. 4 as follows.

The state of NORM0 (1100) corresponds to DN0 of active state transition 250 of FIG. 4. NORM1 (1110) corresponds to DN1, NORM2 (1120) corresponds to DN2.

The state of ACT_BST0 (1200) corresponds to BS0 of the active state transition 250. STB means standby and ACT means active. ACT_BST1 (1210) corresponds to BS2 of ACT_BST2 (1220).

The state of PRCH1 (1510) corresponds to the first PR of the active state transition 250. PRCH2 (1520) corresponds to the second PR and PRCH3 (1530) corresponds to the third PR.

The state of DUAL0 (1300) corresponds to DUO of the standby state transition 310 of FIG. 4. DUAL1 (1310) and DUAL2 (1320) correspond to DU1 and DU2, respectively.

The state of STB_BST0 (1400) corresponds to BS0 of the standby state transition 310 of FIG. 4. STB_BST1 (1410) and STB_BST2 (1420) correspond to BS1 and BS2, respectively.

The state of PRCH3 (1530) corresponds to PR of the standby state transition 310.

FIG. 5 may be divided into the left side diagram and right side diagram, in which the signals of right diagram will be described first.

RFSH is a signal generated for periodic refreshing of DRAM. RFSH=‘1’ indicates that the refresh is enabled. Both of the active side and standby side periodically perform this cycle.

DUP_DRAM=‘1’ is a signal generated by a logic if the first CPU 100A transfers an address and a data signal to the inside of the bus and DRAM control section 110A to start dualization.

TBST=‘1’ is a signal generated as a sign that the active side first CPU 100A starts a burst cycle. On the other hand, TBST=‘0’ means that it is not a burst cycle.

PWR=‘1’ is a signal generated as a sign that the active side first CPU 100A starts to write data in the DRAM memory modules 120A, 120B. On the other hand, PWR=‘0’ means that the data has been read.

DUP_ACK=‘1’ is adapted to be recognized as active side DUP_ACK signal in the right side of FIG. 5, if the DUP_ACK_OUT signal of FIG. 3 is generated by the inactive DUP_ACK 350 and then enter into the inside of the bus and DRAM control section 110B.

CPU_TBST_OUT=‘1’ recognizes that the active side burst cycle has started not dually but singly when the active side state transition starts, that is, when CPU_DRAM=‘1” and TBST=‘1’, and then starts to count the TBST signals (active side burst cycle). A counter counts the burst cycle number of the active side and generates the CPU_TBST_OUT signal when the burst cycle is ended. At this time, the CPU_TBST_OUT signal is checked, and if the CPU_TBST_OUT is ‘1’, it is a sign that the active side single (not dual) burst cycle is terminated.

DUP_TBST_OUT=‘1’ indicates that the active side burst cycle has dually started when 8 the active side state transition is started, i.e., DUP_DRAM=‘1’ and TBST=‘1’. At this time, count for the TBST signals (active side burst cycle) is started. If the burst cycle ends while counting the burst cycle number of the active side, DUP_TBST_OUT signal is generated. In the state of ACT_BST1 (1210), the DUP_TBST_OUT signal is checked, and if it is ‘1’, it is recognized as a sign that the active side dual burst cycle has been terminated.

DUP_MASTER, which is a signal in the left side diagram, is an enable signal for the standby side dual cycle. Specifically, DUP_MASTER=‘1’ an enable signal for the standby side dual cycle generated when DUP_REQ_IN signal transferred to the standby side dual request and response buffer 114B of FIG. 3 is inputted into the bus and DRAM control section 110B.

The relationship between left and right diagrams are as follows.

The left side diagram corresponds to standby single DRAM concurrent writing cycle or standby dual burst DRAM concurrent writing cycle. The right side diagram corresponds to an active burst DRAM concurrent writing cycle, active burst DRAM reading cycle, active dual single DRAM concurrent writing cycle, active dual single DRAM reading cycle, or standby single DRAM reading/writing (access) cycle.

When the right side diagram is in the transition state of “active burst DRAM concurrent writing cycle,” the left side diagram indicates the transition state of “standby dual burst DRAM concurrent writing cycle.”

Example of state transition of right side diagram:

1000→1100→1110→1120→1200→1200→1210→1220→1200→1210→1220→1200→1210→1220→1200→1210→+1510→1520→1530→1000

Example of state transition of left side diagram:

1000→1300→1310→1320→1400→1410→1420→1400→1410→1420→1400→1410→1420→1400→1410→1530→1000

When the right side of the diagram is in the transition state of “active dual burst DRAM reading cycle,” the standby state is not generated in the left side diagram. Only the right side generates the dual burst DRAM reading cycle.

When the right side diagram is in the transition state of “active dual single DRAM concurrent writing cycle,” the left side diagram indicates the transition state of “standby dual single DRAM concurrent writing cycle.”

When the right side diagram is in the transition state of “active dual single DRAM reading cycle,” the standby state is not generated in the left side diagram. Only the dual single DRAM reading cycle of the right side is generated.

When the right side diagram is in the transition state of “standby single DRAM reading/writing (access) cycle”, the standby state is not generated in the left side of the diagram (by CPU_DRAM=‘1’). Only the standby single DRAM reading/writing (access) cycle of the right side is generated.

In conclusion, while 16 bytes [4 (bytes)×4] are recorded per one cycle upon using the burst cycle according to the embodiment of the present invention, the single cycle records a maximum 4 bytes at one time. When comparing the length of time illustrated in FIGS. 2 and 4, the burst cycle does not need a time which is four times longer than that needed by the single cycle. For example, if one single cycle for recording 4 bytes needs a time of 12T (T is unit time), a time of 48T (12T×4) is needed to record 16 bytes. However, the burst writing needs a time of 20 T to record 16 bytes. Therefore, the performance is enhanced by 2.4 times (48T/20T=2.4).

As explained above, the present invention enhances reliability and improves performance in connection with the demand of data communication control of routing processor controller used in super-high speed communication networks or dualization for a main controller used in various communication networks.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A dual processor apparatus capable of burst concurrent writing of data employed in a communication system, comprising:
two processors, one of said two processors being in active mode when the other is in standby mode, the processor in standby mode being operated in dependence on the control of the processor in active mode,
with a central processing unit of the processor in active mode generating a dual request signal and providing a burst cycle allowing n data blocks to be continuously recorded with one row address strobe signal and n column address strobe signals to accommodate a storing of n data blocks in a dynamic memory inside of the processor in active mode during said burst cycle and transmitting the stored data and a corresponding address to said processor in standby mode each time the storing is executed; and
with the central processing unit of said processor in standby mode recognizing the start of the burst cycle concurrent writing when a dual request signal and a burst signal are received from said processor in active mode, and storing said data received from said processor in active mode in a corresponding position in accordance with the addresses received from said processor in active mode.

2. The dual processor apparatus according to claim 1, with each time data is stored in said processor in standby mode, a bus and dynamic memory control section within said processor in standby mode generating a response signal and transmitting the response signal to said processor in active mode.

3. The dual processor apparatus according to claim 1, with each of said processors comprising:
a central processing unit recognizing a mode and generating a corresponding control signal;
a memory module of dynamic memory storing data;
a bus and dynamic memory control section connected to said central processing unit with the bus and dynamic memory maintaining and implementing a burst cycle and causing burst cycle concurrent writing to be executed in said dynamic memory;
a first control buffer buffering the control signal generated from said bus and dynamic memory control section;
a first address buffer buffering an address generated from said bus and dynamic memory control section;
a first data buffer buffering the data generated from said bus and dynamic memory control section;
a second control buffer buffering the control signal outputted from said first control buffer to transfer the control signal to the counterpart processor, or for buffering an address transferred from the counterpart processor and transferring the address to said bus and dynamic memory control section;
a second data buffer buffering data outputted from said first data buffer and transferring the data to the counterpart processor, or for buffering data transferred from the counterpart processor and transferring the data to said dynamic memory; and
a dual request and response buffer buffering and transferring request and response signals for the burst cycle concurrent writing between said bus and dynamic memory control section and the counterpart processor.

4. The dual processor apparatus according to claim 1, further comprising of continuously generating offset addresses in accordance with active side column address strobe.

5. The dual processor apparatus according to claim 1, with each of said processors comprising:
a central processing unit recognizing a mode and generating a corresponding control signal;
a memory module of dynamic memory storing data;
a bus and dynamic memory control section connected to said central processing unit with the bus and dynamic memory maintaining and implementing a burst cycle and causing burst cycle concurrent writing to be executed in said dynamic memory;
a first control buffer buffering the control signal generated from said bus and dynamic memory control section;
a first address buffer buffering an address generated from said bus and dynamic memory control section; and
a first data buffer buffering the data generated from said bus and dynamic memory control section.

6. The dual processor apparatus according to claim 1, with each of said processors further comprising:
a second control buffer buffering the control signal outputted from a first control buffer to transfer the control signal to the counterpart processor, or for buffering an address transferred from the counterpart processor and transferring the address to a bus and dynamic memory control section; and
a second data buffer buffering data outputted from a first data buffer and transferring the data to the counterpart processor, or for buffering data transferred from the counterpart processor and transferring the data to a memory.

7. The dual processor apparatus according to claim 5, with each of said processors further comprising:
a dual request and response buffer buffering and transferring request and response signals for the burst cycle concurrent writing between said bus and dynamic memory control section and the counterpart processor.

8. The dual processor apparatus according to claim 2, with each of said processors comprising:
a central processing unit recognizing a mode and generating a corresponding control signal;
a memory module of dynamic memory storing data;
a bus and dynamic memory control section connected to said central processing unit with the bus and dynamic memory maintaining and implementing a burst cycle and causing burst cycle concurrent writing to be executed in said dynamic memory;
a first control buffer buffering the control signal generated from said bus and dynamic memory control section;
a first address buffer buffering an address generated from said bus and dynamic memory control section;
a first data buffer buffering the data generated from said bus and dynamic memory control section;
a second control buffer buffering the control signal outputted from said first control buffer to transfer the control signal to the counterpart processor, or for buffering an address transferred from the counterpart processor and transferring the address to said bus and dynamic memory control section;
a second data buffer buffering data outputted from said first data buffer and transferring the data to the counterpart processor, or for buffering data transferred from the counterpart processor and transferring the data to said dynamic memory; and
a dual request and response buffer buffering and transferring request and response signals for the burst cycle concurrent writing between said bus and dynamic memory control section and the counterpart processor.

9. A method, comprising:
generating by a central processing unit of a processor in active mode, a dual request signal and providing a burst cycle allowing n data blocks to be continuously recorded with one row address strobe signal and n column address strobe signals to accommodate a storing of n data blocks in a dynamic memory inside of the processor in active mode during said burst cycle and transmitting the stored data and a corresponding address to a processor in standby mode each time the storing is executed, said processor in active mode and said processor in standby mode being at least two processors of a plurality of processors where one of said two processors being in active mode when the other is in standby mode, the processor in standby mode being operated in dependence on the control of the processor in active mode; and
recognizing by the central processing unit of said processor in standby mode, the start of the burst cycle concurrent writing when a dual request signal and a burst signal are received from said processor in active mode, and storing said data received from said processor in active mode in a corresponding position in accordance with the addresses received from said processor in active mode.

10. The method of claim 9, with each time data is stored in said processor in standby mode, a bus and dynamic memory control section within said processor in standby mode generating a response signal and transmitting the response signal to said processor in active mode.

11. The method of claim 9, with each of said processors comprising:
recognizing a mode and generating a corresponding control signal by a central processing unit;
storing data by a memory module of dynamic memory;
maintaining and implementing a burst cycle and causing burst cycle concurrent writing to be executed in said dynamic memory by a bus and dynamic memory control section connected to said central processing unit with the bus and dynamic memory;
buffering the control signal generated from said bus and dynamic memory control section by a first control buffer;
buffering an address generated from said bus and dynamic memory control section by a first address buffer;
buffering the data generated from said bus and dynamic memory control section by a first data buffer;
buffering the control signal outputted from said first control buffer to transfer the control signal to the counterpart processor by a second control buffer or buffering an address transferred from the counterpart processor and transferring the address to said bus and dynamic memory control section by said second control buffer;
buffering data outputted from said first data buffer and transferring the data to the counterpart processor by a second data buffer, or buffering data transferred from the counterpart processor and transferring the data to said dynamic memory by said second data buffer; and
buffering and transferring request and response signals for the burst cycle concurrent writing between said bus and dynamic memory control section and the counterpart processor by a dual request and response buffer.

12. The method of claim 10, with each of said processors comprising:
recognizing a mode and generating a corresponding control signal by a central processing unit;
storing data by a memory module of dynamic memory;
maintaining and implementing a burst cycle and causing burst cycle concurrent writing to be executed in said dynamic memory by a bus and dynamic memory control section connected to said central processing unit with the bus and dynamic memory;
buffering the control signal generated from said bus and dynamic memory control section by a first control buffer;
buffering an address generated from said bus and dynamic memory control section by a first address buffer;
buffering the data generated from said bus and dynamic memory control section by a first data buffer;
buffering the control signal outputted from said first control buffer to transfer the control signal to the counterpart processor by a second control buffer or buffering an address transferred from the counterpart processor and transferring the address to said bus and dynamic memory control section by said second control buffer;
buffering data outputted from said first data buffer and transferring the data to the counterpart processor by a second data buffer, or buffering data transferred from the counterpart processor and transferring the data to said dynamic memory by said second data buffer; and
buffering and transferring request and response signals for the burst cycle concurrent writing between said bus and dynamic memory control section and the counterpart processor by a dual request and response buffer.

13. The method of claim 9, with each of said processors comprising:
recognizing a mode and generating a corresponding control signal by a central processing unit;
storing data by a memory module of dynamic memory; and
maintaining and implementing a burst cycle and causing burst cycle concurrent writing to be executed in said dynamic memory by a bus and dynamic memory control section connected to said central processing unit with the bus and dynamic memory.

14. The method of claim 13, further comprising:
buffering the control signal generated from said bus and dynamic memory control section by a first control buffer;
buffering an address generated from said bus and dynamic memory control section by a first address buffer; and
buffering the data generated from said bus and dynamic memory control section by a first data buffer.

15. The method of claim 14, further comprising:
buffering the control signal outputted from said first control buffer to transfer the control signal to the counterpart processor by a second control buffer or buffering an address transferred from the counterpart processor and transferring the address to said bus and dynamic memory control section by said second control buffer; and
buffering data outputted from said first data buffer and transferring the data to the counterpart processor by a second data buffer, or buffering data transferred from the counterpart processor and transferring the data to said dynamic memory by said second data buffer.

16. The method of claim 14, further comprising of buffering and transferring request and response signals for the burst cycle concurrent writing between said bus and dynamic memory control section and the counterpart processor by a dual request and response buffer.

17. An apparatus, comprising:
a plurality of processors with at least one of said plurality of processors being in active mode when at least a second processor is in standby mode, the processor in standby mode being operated in dependence on the control of the processor in active mode,
with a central processing unit of the processor in active mode generating a dual request signal and providing a burst cycle allowing n data blocks to be continuously recorded with one row address strobe signal and n column address strobe signals to accommodate a storing of n data blocks in a dynamic memory inside of the processor in active mode during said burst cycle and transmitting the stored data and a corresponding address to said processor in standby mode each time the storing is executed; and
with the central processing unit of said processor in standby mode recognizing the start of the burst cycle concurrent writing when a dual request signal and a burst signal are received from said processor in active mode, and storing said data received from said processor in active mode in a corresponding position in accordance with the addresses received from said processor in active mode.

18. The apparatus of claim 17, with each time data is stored in said processor in standby mode, a bus and dynamic memory control section within said processor in standby mode generating a response signal and transmitting the response signal to said processor in active mode.

19. The apparatus of claim 17, with each one of said processors comprising:
a central processing unit recognizing a mode and generating a corresponding control signal;
a memory module of dynamic memory storing data;
a bus and dynamic memory control section connected to said central processing unit with the bus and dynamic memory maintaining and implementing a burst cycle and causing burst cycle concurrent writing to be executed in said dynamic memory;
a first control buffer buffering the control signal generated from said bus and dynamic memory control section;
a first address buffer buffering an address generated from said bus and dynamic memory control section;
a first data buffer buffering the data generated from said bus and dynamic memory control section;
a second control buffer buffering the control signal outputted from said first control buffer to transfer the control signal to the counterpart processor, or for buffering an address transferred from the counterpart processor and transferring the address to said bus and dynamic memory control section;
a second data buffer buffering data outputted from said first data buffer and transferring the data to the counterpart processor, or for buffering data transferred from the counterpart processor and transferring the data to said dynamic memory; and
a dual request and response buffer buffering and transferring request and response signals for the burst cycle concurrent writing between said bus and dynamic memory control section and the counterpart processor.

20. The apparatus of claim 18, with each one of said processors comprising:
a central processing unit recognizing a mode and generating a corresponding control signal;
a memory module of dynamic memory storing data;
a bus and dynamic memory control section connected to said central processing unit with the bus and dynamic memory maintaining and implementing a burst cycle and causing burst cycle concurrent writing to be executed in said dynamic memory;
a first control buffer buffering the control signal generated from said bus and dynamic memory control section;
a first address buffer buffering an address generated from said bus and dynamic memory control section;
a first data buffer buffering the data generated from said bus and dynamic memory control section;
a second control buffer buffering the control signal outputted from said first control buffer to transfer the control signal to the counterpart processor, or for buffering an address transferred from the counterpart processor and transferring the address to said bus and dynamic memory control section;
a second data buffer buffering data outputted from said first data buffer and transferring the data to the counterpart processor, or for buffering data transferred from the counterpart processor and transferring the data to said dynamic memory; and
a dual request and response buffer buffering and transferring request and response signals for the burst cycle concurrent writing between said bus and dynamic memory control section and the counterpart processor.
